(19) United States
(12) Patent Application Publication
(10) Pub. No.: US 2005/0115775 A1
(43) Pub. Date: Jun. 2, 2005

(54) Vehicle restraint system

(76) Inventors: Stuart Thomson, Downers Grove, IL (US); Martin Conneally, Downers Grove, IL (US)

Correspondence Address: David C. Brezina;BARNES & THORNBURG, P.O. Box 2786, Chicago, IL, 60690-2786, US

(21) Appl. No.: 10/725,112

(22) Filed: Dec. 1, 2003

(51) Int. Cl. B60T 1/00

(52) U.S. Cl. 188/4 R

(57) ABSTRACT

A system for restraining the movement of a vehicle having a wheel with a tire thereon during shipment of the vehicle on a support surface. A chock for engaging at least one of the front or back surfaces of the tire. A strap take-up mechanism engages the support surface and is positioned adjacent the other circumferential surface of the tire. An elongated restraining strap which at one end engages the chock, extends over tire and engages the tire, and at the other end engages the strap take-up mechanism. The strap take-up mechanism includes a pair of legs each engaging the support surface and having a cylindrically shaped, slotted and rotatable hinge pin mounted to the legs for receiving the take-up end of the strap and about which the strap can be wound upon rotation of the cylinder. A handle associated with the cylinder and legs for rotating the cylinder so as to wrap the strap about the cylinder and for securing the cylinder relative to the legs so as to prevent further rotation of the cylinder.

### FIELD OF THE DISCLOSURE

This disclosure relates to the shipment of wheeled vehicles and more particularly to a system to restrain movement of the vehicles.

### BACKGROUND

Transportation or shipment of vehicles such as sport utility vehicles (SUVs), from one place to another is common. Typically the vehicles are shipped by railroad, truck or other carrier. The carrier usually includes a support surface (such as a railroad car floor) on which the vehicle rests.

In order to restrain movement of the vehicle in the carrier, a chock or wheel block may be positioned adjacent each of the vehicle's wheels so as to minimize the movement of the vehicle relative to the carrier. The movement can occur due to collisions, bumps, etc. One such chock system is shown in U.S. Pat. No. 5,302,063, issued Apr. 12, 1994, the disclosure of which is incorporated herein by reference. In some circumstances, the support surface or flooring for the carrier is a grate-like system to which the chock is mounted. U.S. Pat. No. 5,302,063 discloses such a flooring system.

In the event the carrier is bumped, the vehicle may rise upwardly and the wheel may “jump over” the chock. If that occurs, the vehicle may not be restrained during the remainder of the shipment.

In addition to the chock restraint systems, there are tie-down and strap restraint systems where a strap or similar system is fitted over the vehicle tire and affixed to the carrier floor so as to restrain movement of the wheel and thus the vehicle relative to the carrier floor. Usually the strap is secured at both the front and back of the tire. (See U.S. Pat. Nos. 4,659,266 and 4,668,140 discussed in U.S. Pat. No. 5,302,063 cited above). Moreover, the tie down systems may form a rigid connection between the vehicle and the carrier. These systems are complete in and of themselves and do not supplement existing chock systems particularly when mounted to a grate-like floor.

However, in some circumstances where there is only a chock, the vehicle may not be properly restrained and may “jump over” the chock.

It is the object of this invention to provide a supplemental system which cooperates with the chock to more fully, but flexibly, restrain the movement of the vehicle. These and other objects will become apparent from the following description and appended claims.

### SUMMARY

There is provided a supplemental strap-tie down restraint and strap take-up mechanism for use with existing chock and grate-like carrier floor systems to restrain vehicle movement.

The supplemental system includes a strap that can be anchored at one end to an existing chock either at the front or the back of a tire, be positioned on and over the vehicle tire and be secured at the other end to a rotatable hinge-like take-up mechanism that is mounted to the grate-like floor at the other of the front or back of the tire.

Thus, if the carrier is bumped, the wheel and thus the vehicle can move, but with the system disclosed herein, the movement is flexibly restrained and the “jump-over” problem is minimized.

### BRIEF DESCRIPTION OF THE DRAWING

FIG. 1 is a perspective style view of a railroad carrier loaded with vehicles for shipment;

FIG. 2 is a view of a vehicle front tire with the chock, strap-restraint, take-up mechanism and grate-like flooring;

FIG. 3 is a view of the vehicle chock in place and mounted to the grate-like floor;

FIG. 4 is a view of the take-up mechanism mounted to the grate-like floor;

FIG. 5 is a view showing the strap and an anchor or retainer end plate; and

FIG. 6 is a perspective view of an assembled take-up mechanism;

FIG. 7 is an exploded and perspective view of the parts of the take-up mechanism.

### DESCRIPTION OF THE PREFERRED EMBODIMENT

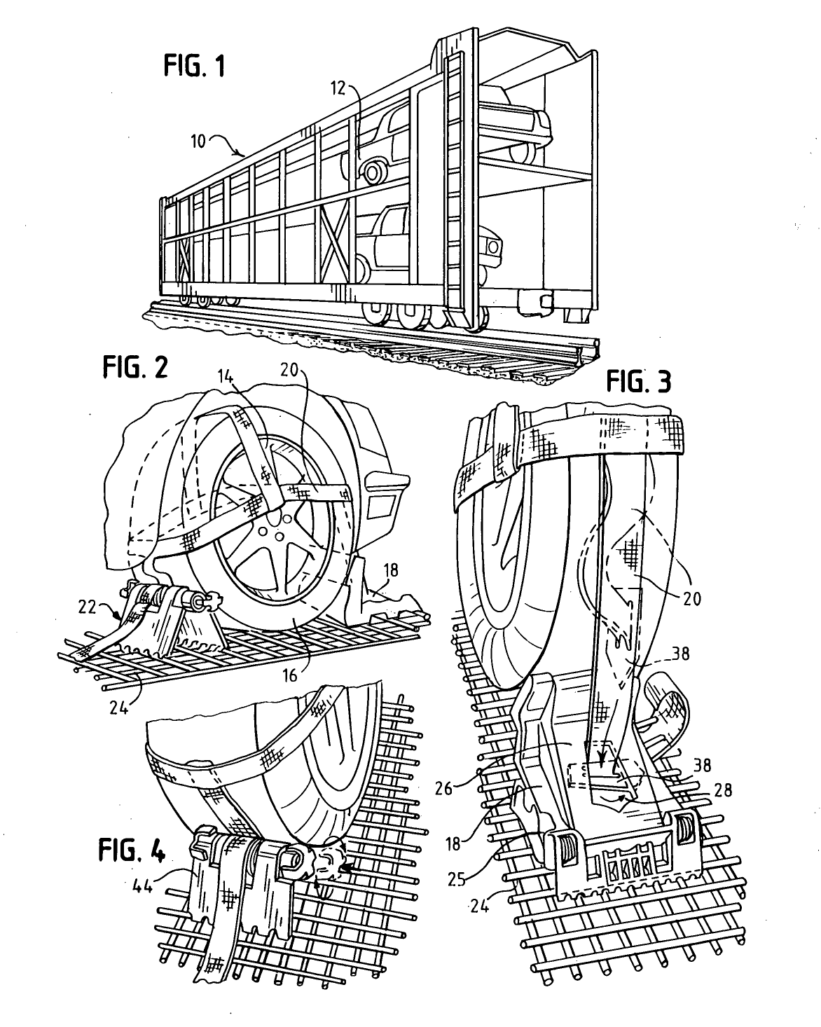

Referring to FIGS. 1 and 2, a railroad car or carrier 10 is shown carrying a plurality of vehicles such as 12. Each of the vehicles includes four wheels such as indicated by numeral 14 and each of the wheels has mounted thereon a circular tire such as 16.

A chock assembly or wheel blocking assembly such as 18 (as described in U.S. Pat. No. 5,302,036) is provided at the front of the tire. A strap assembly 20 is provided that fits on and over the tire and extends to the tire back. A take-up system 22 generally, for the strap, grips the grate-like floor or support surface 24 at the rear of the tire. The chock assembly 18 and the grate surface 24 are commercially available. The strap and take-up mechanism are a supplemental assembly to be used with the chock and grate-like floor to restrain vehicle movement.

Referring now to FIG. 3, the chock assembly 18 is shown secured to the grate-like floor 24. Chock assembly 18 includes a base 25 and a central hinged plate 26 generally that includes an elongated 5-sided opening 28. A five-sided retainer or anchor plate 38 having a complementary shape to the opening 28 is secured to the strap 20 at one end. The anchor is then fitted into the opening 28 and rotated 90° so as to anchor the strap 20 to the chock.

Referring to FIG. 5, the strap 20 is shown, one end 30 is to be secured in the chock and the other end 32 is the take-up end. The strap can be a single member extending over the tire or can include a tire engaging net-like section 33. The net-like section includes an elliptically shaped portion 34 which is constructed to fit about and engage the sides of the tire and a transverse loop portion 36 which is arranged to engage the top of the tire and is secured to the sides of the elliptical portion 34.

The chock anchor 38 is elongated and five-sided and has a complementary shape to the chock opening 28 so as to fit therein. The anchor includes slots 40 and 42 through which the strap is fitted, looped and sewn together as shown in FIG. 5. Using this construction, the anchor plate 38 can be fitted into and rotated in the chock opening 28 and one end of the strap is thus secured to the opening.

The tire strap's net section can be fitted over the top of the tire so that the elliptical portion 34 may engage either side of the tire. The loop 36 rests the top of the tire.

Take-up end 32 is fitted into the take-up mechanism 22 generally which is intended to wind the take-up end 32 and to cause the entire strap assembly to snuggly engage the tire. Thus, if the vehicle experiences any bumping or jostling and if the vehicle tire rises, it is restrained and returns into engagement with the carrier floor and the chock. In other words, the take-up mechanism and strap provide some give or flexibility and still restrains the vehicle.

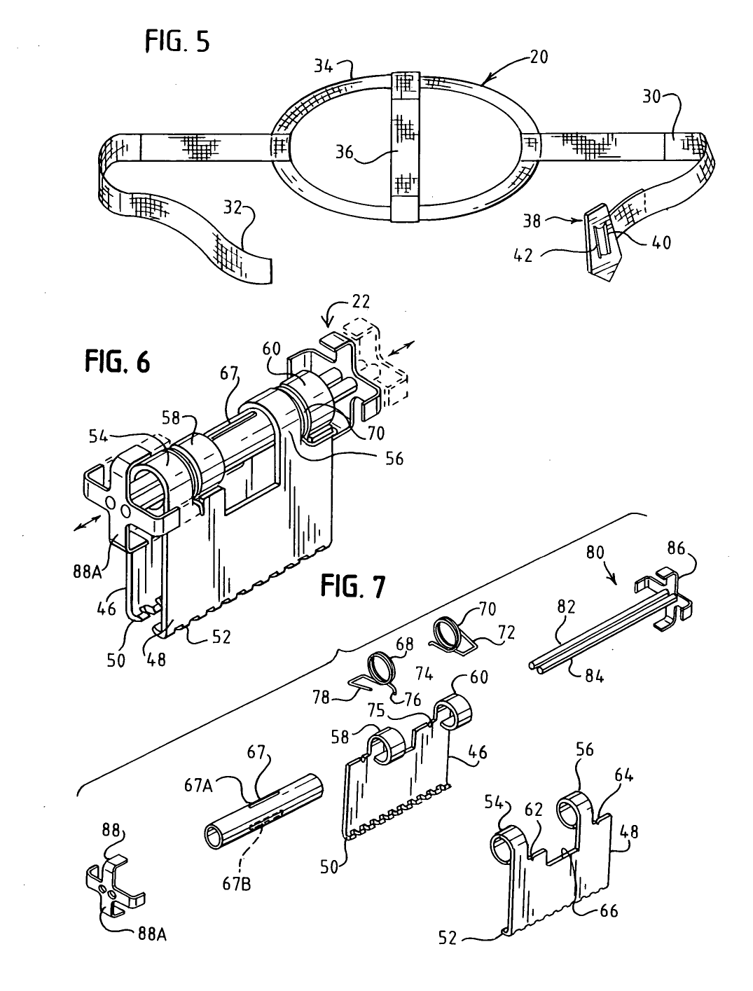

Referring now to FIG. 6, the take-up mechanism 22 is shown and includes a pair of legs or hinge plates 46 and 48. Each of the plates include grate grasping claws 50 and 52 along the bottom edge of the plate. At the top of the plates there are cylindrical hinge pin receiving elements such as 54 and 56 associated with plate 48 and elements 58 and 60 associated with plate 46. Each of the plates, such as 46, includes spring retaining grooves such as 62 and 64 and a large central cutout 66 for receiving the strap. An elongated, cylindrical, hollow and slotted hinge pin 67 is provided and fits in the hinge-like elements 54, 56, 58 and 60. The pin 67 is held in place relative to the legs 46 and 48 by a pair of coiled springs 68 and 70. The springs retain the hinge pin in position within the hinge elements 54, 56, 58 and 60 as shown in FIG. 6.

The spring 70 includes legs 72 and 74. Leg 72 fits into the groove 64, about the edge of the plate. The leg 74 fits into the groove 75 adjacent the element 60 on plate 46. The spring 68 fits about the end of the hinge pin and has legs 76 and 78. The leg 76 fits in groove 62 and the leg 78 fits in a similar groove on plate 46 and about the edge of the plate. It is noted that both legs 72 and 78 are elongated and act to position the pin in the hinge elements. The hinge pin 67 is thus held within the hinge-like elements but can rotate therein and is positioned relative to the elements by the springs 68 and 70.

A winding mechanism 80 generally includes a pair of spaced and elongated rods 82 and 84 which extend through the hinge pin 67 and to which are secured to cross-shaped handles 86 and 88. It is noted that the space between rods 82 and 84 is aligned with slots 67A and 67B in the hinge pin.

Thus, the strap end 32 is fitted through the slots 67A and 67B and between the rods 82 and 84. One of the handles 86 or 88 is then rotated so as to rotate the hinge pin and wind the strap end 32 thereabout. When the winding is terminated, usually when the strap is snug, the rods 82 and 84 and one of the handles 86 or 88 is slid in one direction or the other toward the edges of the leg plates. Since the handles are cross-shaped, a handle leg such as 88A can fit between the plates 46 and 48 and thus, when the hinge pin is turned the handle can engage the leg and prevent rotation of the handle and hinge pin and loosening of the strap.

It is appreciated that the claws 50 and 52 grasp the grate 24 and thus hold the take-up mechanism to the floor. But the take-up mechanism can exhibit some give or flexibility. The assembled restraint system is seen in FIG. 2 where the chock 18 is shown. The strap system is positioned over the tire and the take-up mechanism is in place.

Numerous changes and modifications can be made to the embodiment disclosed here without departing from the spirit and scope of the invention.

1. A system for restraining the movement of a vehicle having a wheel with a tire thereon during shipment of the vehicle on a support surface, including:
a chock for engaging one of the front or back circumferential surfaces of the tire;
a strap take-up mechanism adapted to engage the support surface and to be positioned adjacent the other circumferential surface of the tire;
an elongated restraining strap which at one end engages the chock, extends over the tire and engages the tire, and at the other end engages a strap take-up mechanism;
said take-up mechanism including a pair of legs each engaging the support surface and a cylindrical, slotted and rotatable hinge pin mounted to the legs for receiving the take-up end of the strap and about which the strap can be wound upon rotation of the cylinder; and
a handle associated with the hinge pin and legs for rotating the hinge pin so as to wind the strap about the hinge pin and for securing the hinge pin relative to the legs so as to prevent further rotation of the hinge pin.

2. A restraint system as in claim 1 wherein:
each of the plate-like legs includes a plurality of gripping claws along one edge and spaced hinge pin receiving elements along the opposite edge;
said slotted and hinge pin is mounted to said plate and said hinge pin receiving members; and
said handle connected to the hinge pin for rotating the hinge pin and movable between a locking position in engagement with at least one of said legs so as to prevent the handle and the hinge pin from rotating and a rotatable position for strap take-up.

3. A restraint system as in claim 2 wherein each of said hinge-pin receiving elements is cylindrically shaped.

4. A restraint system as in claim 1 wherein said handle is associated with the hinge pin for rotating the pin and movable between a locking position and engagement with at least one of said legs so as to prevent the handle and hinge pin from rotating and an unlocked rotatable position for strap take-up.

5. A restraint system as in claim 1 wherein each of said hinge pin receiving elements is hollow.

6. A restraint system as in claim 1 wherein there is further provided a pair of elongated rods that extend through the hollow hinge pin with handles being mounted to each end of the rods.

7. A restraint system as in claim 1 wherein said chock defines a shaped opening and there is further provided an anchor having a shape substantially similar to said shaped opening so as to pass therethrough, which anchor is secured to one end of the elongated strap.

8. A restraint system as in claim 7 wherein said shaped opening has five sides and said anchor has five sides.

9. A restraint system as in claim 8 wherein said opening and said anchor are each elongated.

10. A restraining system as in claim 1 wherein there is further provided a pair of coiled springs, each mounted to each of said legs, each spring associated with a hinge pin receiving elements, adapted to receive said hinge pin and is positioned to restrain the lateral movement of the pin.

11. A restraining system as in claim 1 wherein said hinge pin defines a pair of opposed strap-receiving slots,
said winding mechanism also including a pair of spaced and elongated rods which extend through the hinge pin and are slidable therein;
said hinge pin being associated with each end of the rods; and
said pin slots and spaced rods being aligned so as to receive the strap and therethrough.

12. A supplemental system for use in restraining movement of a wheeled vehicle positioned on a support surface during shipment of the vehicle and for cooperation with a wheel chock that engaged one of the front or back of a wheel;
said supplemental system including a strap take-up mechanism adapted to engage the support surface and be positioned adjacent the other of the front or back surface of the tire,
an elongated restraining strap which at one end engages said chock, extends over the tire and engages the tire, and at the other end engages the strap take-up mechanism;
said strap take-up mechanism including a pair of legs each engaging the support surface and a rotatable, cylindrical and hollow slotted hinge pin mounted to the legs for receiving the other end of the strap and about which the strap can be wound upon rotation of the cylinder; and
a handle associated with the hinge pin and legs for rotating the cylinder so as to wind the strap about the cylinder and for securing the hinge pin relative to the leg so as to prevent further rotation of the hinge pin.

13. A supplemental restraint system as in claim 12 wherein:
each of the plate-like legs includes a plurality of gripping claws along one edge and spaced hinge pin receiving elements along the opposite edge;
said slotted and cylindrical hinge pin is mounted to said plate and said hinge pin receiving members; and
said handle connected to the hinge pin for rotating the pin and movable between a locking position in engagement with at least one of said legs so as to prevent the handle and the hinge pin from rotating and a rotatable position for strap take-up.

14. A supplemental restraint system as in claim 13 wherein each of said hinge-pin receiving elements is cylindrically shaped.

15. A supplemental restraint system as in claim 12 wherein said handle is associated with the hinge pin for rotating the pin and movable between a locking position and engagement with at least one of said legs so as to prevent the handle and hinge pin from rotating and an unlocked rotatable position for strap take-up.

16. A supplemental restraint system as in claim 12 wherein each of said hinge pin receiving elements is hollow.

17. A supplemental restraint system as in claim 12 wherein there is further provided a pair of elongated rods that extend through the hollow hinge pin with handles being mounted to each end of the rods.

18. A supplemental restraining system as in claim 12 wherein there is further provided a pair of coiled springs, each mounted to each of said legs, each spring associated with a hinge pin receiving elements, adapted to receive said hinge pin and is positioned to restrain the lateral movement of the pin.

19. A supplemental restraining system as in claim 12 wherein said hinge pin defines a pair of opposed strap-receiving slots,
said winding mechanism also including a pair of spaced and elongated rods which extend through the hinge pin and are slidable therein;
said hinge pin being associated with each end of the rods; and
said pin slots and spaced rods being aligned so as to receive the strap and therethrough.
